(19) United States
(12) Patent Application Publication
(10) Pub. No.: US 2003/0172211 A1
(43) Pub. Date: Sep. 11, 2003

(54) Dual input/output automatic selection device

(76) Inventors: Chien-Pang Huang, Hsinchu (TW); Hei-Tai Hong, Hsinchu (TW)

Correspondence Address: MARTINE & PENILLA, LLP, 710 LAKEWAY DRIVE, SUITE 170, SUNNYVALE, CA, 94085, US

(21) Appl. No.: 10/155,189

(22) Filed: May 24, 2002

(30) Foreign Application Priority Data
Mar. 5, 2002 (TW) 91202652

(51) Int. Cl. G06F 13/12

(52) U.S. Cl. 710/72

(57) ABSTRACT

A dual input/output automatic selection device is disclosed to provide an input/output interface between projectors and peripheral products generating VGA (Video Graphics Array) signals. The dual input/output automatic selection device comprises an input/output unit and an image processing unit. The input/output unit has two VGA ports, each of which is connected to a switch circuit having a VGA image data input path and a VGA image data output path. Each of the two VGA ports serves as either an input port or an output port depending on whether the VGA image data input path or the VGA image data output path is activated. The image processing unit has a switch circuit by which VGA image data from either of the two VGA ports is received for processing. Compared to the conventional unidirectional single input/output interface, the dual input/output automatic selection device has greatly improved the connection accessibility and mobility between the projectors and peripheral products.

### BACKGROUND OF THE INVENTION

1. Field of the Invention

The present invention relates to a dual input/output automatic selection device and, more particularly, to a dual input/output automatic selection device capable of transmitting image data bi-directionally.

2. Description of the Related Art

In the past, a projector was categorized as a business-oriented device, and its function was to project extracted images onto an image display device through image transmission processing. However, the users of the projectors have been extended to the common consumers because the techniques of producing projectors have been advanced and the variety of product functions has been increased. Nonetheless, the common consumers often complain that when they use a conventional unidirectional single input/output device (i.e., the device has one input terminal and one output terminal, and both terminals are unidirectional), they cannot figure out the corresponding VGA (Video Graphics Array) I/O (input/output) relation between a projector and peripheral products. Besides, the consumers may also encounter that the specification for the VGA I/O on a projector is not clear enough; therefore, they have to practice connections between the projector and peripheral products by means of trial and error in order to determine which one of terminals is for input and which one for output. Furthermore, the connector type for VGA input should match with that for VGA output in order to prevent any damage risk caused by plugging into a wrong type.

Moreover, any electronic peripheral products, as long as they have the functions of transmitting, displaying, or storing the VGA image data, can expand the application range for their corresponding projector by connecting to the projector for extracting images. That is, possible applications of the projector are no longer limited to a single projector. However, the conventional projector can only process the VGA image data in a single direction, and the interface of the conventional projector is unidirectional single input/output interface. As a result, the mobility of sharing the VGA image data between a projector and its corresponding peripheral products is confined.

Therefore, for common consumers, when they are connecting a conventional projector to its corresponding peripheral products, they have to face the risk of making an incorrect connection (i.e., they have to determine on their own which electronic product is for inputting VGA image data and which electronic product is for outputting VGA image data). Furthermore, if there is more than one piece of electronic peripheral product to be connected and all of the image data belong to either input or output signal, then the consumer has to keep on changing the connecting joints for those input/output image data. Doing so is not only a consumption of time but also the connecting joints can be impaired more easily or can cause a loose connection due to the high frequency of plugging-in-and-out.

### SUMMARY OF THE INVENTION

In order to solve the above problems, the object of the present invention is to provide a dual input/output automatic selection device for a projector, which is capable of transmitting image data bi-directionally, thereby greatly improving the connection accessibility and mobility between the projector and peripheral products.

A dual input/output automatic selection device according to the present invention comprises an input/output unit for transmitting VGA image data and an image processing unit for detecting and processing the VGA image data transmitted from the input/output unit. The input/output unit is provided with a first VGA port, a second VGA port, a first switch circuit connected to the first VGA port and having a first VGA image data input path and a first VGA image data output path, a second switch circuit connected to the second VGA port and having a second VGA image data input path and a second VGA image data output path, a first driving circuit connected to the first VGA image data output path and the second VGA image data input path, and a second driving circuit connected to the first VGA image data input path and the second VGA image data output path.

The image processing unit is provided with a third switch circuit and a signal converter. The third switch circuit has a first VGA image data path connected to the first VGA image data input path and a second VGA image data path connected to the second VGA image data input path. The signal converter is connected to the third switch circuit.

### BRIEF DESCRIPTION OF THE DRAWINGS

These and other objects, features, and advantages of the present invention will become apparent with reference to the following descriptions and accompanying drawings, wherein:

FIG. 1 is a block diagram showing the dual input/output automatic selection device of the present invention; and

FIG. 2 is a flow chart showing the operation of the dual input/output automatic selection device of the present invention.

### DETAILED DESCRIPTION OF THE PREFERRED EMBODIMENTS

The preferred embodiments according to the present invention will be described in detail with reference to the drawings.

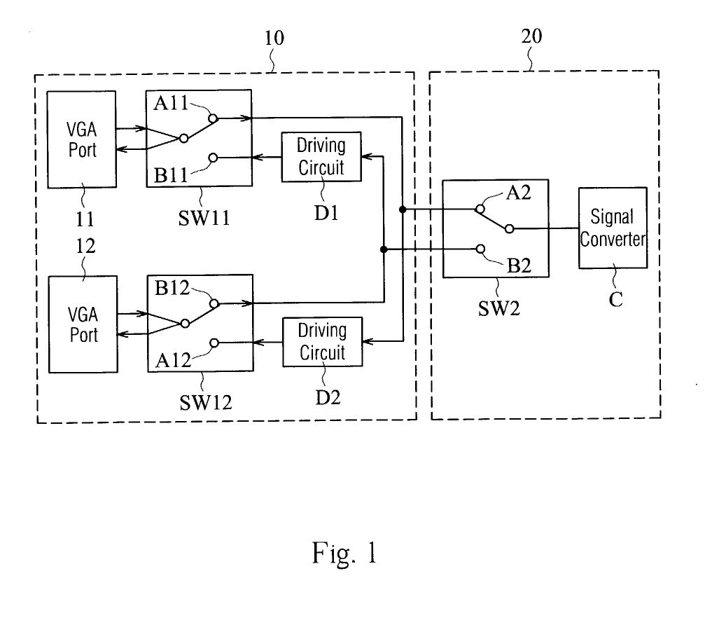

With reference to the block diagram shown in FIG. 1, a dual input/output automatic selection device according to an embodiment of the present invention comprises an input/output unit 10 for transmitting VGA image data and an image processing unit 20 for detecting and processing the VGA image data transmitted from the input/output unit.

The input/output unit 10 comprises two sets of input/output circuits coupled in parallel with each other. The first set of the input/output circuit consists of a VGA port 11, a switch circuit SW11, and a driving circuit D1. The VGA port 11 is connected to the switch circuit SW11. The switch circuit SW11 comprises a VGA image data input path with a node A11, which is referred to as SWITCH_11(A), and a VGA image data output path with a node B11, which is referred to as SWITCH_11(B). The second set of the input/output circuit consists of a VGA port 12, a switch circuit SW12, and a driving circuit D2. The VGA port 12 is connected to the switch circuit SW12. The switch circuit SW12 comprises a VGA image data input path with a node B12, which is referred to as SWITCH_12(B), and a VGA image data output path with a node A12, which is referred to as SWITCH_12(A). In addition, one terminal of the driving circuit D1 of the first set of the input/output circuit is connected to the VGA image data output path SWITCH_11(B), and the other terminal of the driving circuit D1 is connected to the VGA image data input path SWITCH_12(B) of the second set of the input/output circuit, while one terminal of the driving circuit D2 of the second set of the input/output circuit is connected to the VGA image data output path SWITCH_12(A), and the other terminal of the driving circuit D2 is connected to the VGA image data input path SWITCH_11(A) of the first set of the input/output circuit.

Furthermore, the image processing unit 20 comprises a switch circuit SW2 and a signal converter C. The switch circuit SW2 comprises a first image data path with a node A2, which is referred to as SWITCH_2(A), and a second image data path with a node B2, which is referred to as SWITCH_2(B). The switch circuit SW2 are connected to the two driving circuits (D1 and D2) of the two sets of the input/output circuits of the input/output unit 10 through the nodes A2 and B2, respectively, and to the signal converter C. The signal converter C may be an analog to digital converter for converting analog image data into digital image data, followed by outputting the digital image data for further application.

According to the dual input/output automatic selection device of the embodiment of the present invention, because the VGA ports 11 and 12 are connected to the switch circuits SW11 and SW12, respectively, both of the VGA ports 11 and 12 can function as either an input port or output port depending on the states of the switch circuits SW11 and SW12. As a result, the possible operating conditions are listed in the following:

1. no image data is input;

2. one single VGA image data is input into the VGA port 11;

3. one single VGA image data is input into the VGA port 12;

4. two different VGA image data are input into the VGA port 11 and the VGA port 12, respectively;

5. one signal VGA image data is input into the VGA port 11 and then output from the VGA port 12; and

6. one signal VGA image data is input into the VGA port 12 and then output from the VGA port 11.

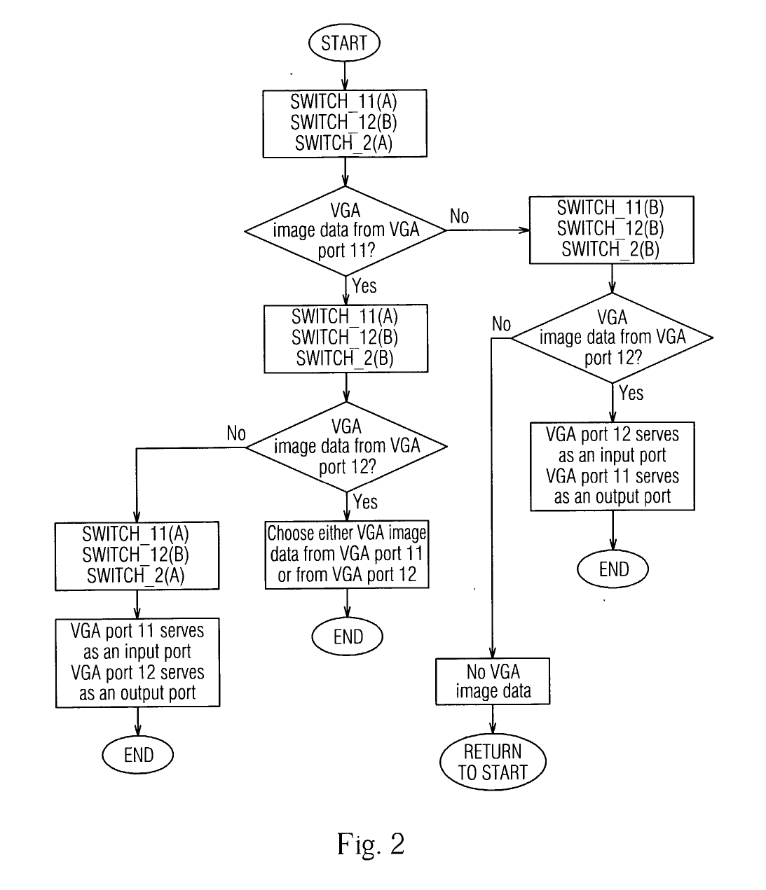

A flow chart that illustrates the above-mentioned operating conditions of VGA image data transmission of the dual input/output automatic selection device according to the present invention will be explained in detail below with reference to FIG. 2.

At the beginning states of the switch circuits SW11 and SW2, the nodes A11 and A2 are both connected such that the paths SWITCH_11(A) and SWITCH_2(A) are activated. On the other hand, at the beginning state of SW12, the node B12 is connected such that the path SWITCH_12(B) is activated.

When VGA image data from the VGA port 11 is detected, the switch circuit SW2 is switched to the node B2. That is, the path SWITCH_2(B) is activated. Next, whether there is image data from the VGA port 12 or not is detected. If there is image data from the VGA port 12, then the users can choose either image data from the VGA port 11 or from the VGA port 12 to be input into the image processing unit 20. If there is no image data from the VGA port 12, then the switch circuits SW12 and SW2 are switched to the nodes A12 and A2, respectively. That is, the paths SWITCH_11(A) and the SWITCH_12(A) are both activated. As a result, the VGA port 11 serves as an input port and the VGA port 12 serves as an output port while the path SWITCH_2(A) is activated for transmitting VGA image data into the signal converter C.

On the contrary, if there is no image data from the VGA port 11, the switch circuits SW11 and SW2 are switched to the nodes B11 and B2, respectively. That is, the paths SWITCH_11(B) and SWITCH_12(B) are activated. Next, whether there are image data from the VGA port 12 or not is detected. At that moment, if there are image data from the VGA port 12, then the VGA port 12 serves as an input port and the VGA port 11 serves as an output port while the path SWITCH_2(B) is activated for transmitting VGA image data into the signal converter C. If there is no image data from the VGA port 12, then the switch circuits SW11 and SW2 are switched to the nodes A11 and A2, respectively. That is, the paths SWITCH_11(A) and SWITCH_2(A) are activated. As a result, the whole operating state of the dual input/output automatic selection device according to the present invention goes back to the beginning configuration.

While the present invention has been described by way of example and in terms of the preferred embodiment, it is to be understood that the present invention is not limited to the disclosed embodiment. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A dual input/output automatic selection device, comprising:
an input/output unit for transmitting VGA image data, providing with a first VGA port, a second VGA port, a first switch circuit connected to said first VGA port and having a first VGA image data input path and a first VGA image data output path, a second switch circuit connected to said second VGA port and having a second VGA image data input path and a second VGA image data output path, a first driving circuit connected to said first VGA image data output path and said second VGA image data input path, and a second driving circuit connected to said first VGA image data input path and said second VGA image data output path; and
an image processing unit for detecting and processing the VGA image data transmitted from said input/output unit, providing with a third switch circuit having a first VGA image data path connected to said first VGA image data input path and a second VGA image data path connected to said second VGA image data input path, and a signal converter connected to said third switch circuit.

2. The dual input/output automatic selection device as claimed in claim 1, wherein said first VGA image data input path is activated and said first VGA image data output path is deactivated when said first switch circuit receives VGA image data from said first VGA port.

3. The dual input/output automatic selection device as claimed in claim 1, wherein said first VGA image data input path is deactivated and said first VGA image data output path is activated when said first switch circuit receives VGA image data from said first driving circuit.

4. The dual input/output automatic selection device as claimed in claim 1, wherein said second VGA image data input path is activated and said second VGA image data output path is deactivated when said second switch circuit receives VGA image data from said second VGA port.

5. The dual input/output automatic selection device as claimed in claim 1, wherein said second VGA image data input path is deactivated and said second VGA image data output path is activated when said second switch circuit receives VGA image data from said second driving circuit.

6. The dual input/output automatic selection device as claimed in claim 1, wherein said third VGA image data input path is activated and said fourth VGA image data input path is deactivated when said third switch circuit receives VGA image data from said first switch circuit.

7. The dual input/output automatic selection device as claimed in claim 1, wherein said third VGA image data input path is deactivated and said fourth VGA image data input path is activated when said third switch circuit receives VGA image data from said second switch circuit.

8. The dual input/output automatic selection device as claimed in claim 1, wherein said signal converter is an analog-to-digital converter for converting an analog signal to a digital signal.
